(19) United States
(12) Patent Application Publication
(10) Pub. No.: US 2025/0226121 A1
(43) Pub. Date: Jul. 10, 2025

(54) Pebble bed reactor pebbles coated with materials developed to minimize radioactive dust from carbon pebbles

(71) Applicant: Zachary Charles Crouch, Knoxville, TN (US)

(72) Inventor: Zachary Charles Crouch, Knoxville, TN (US)

(21) Appl. No.: 18/405,112

(22) Filed: Jan. 5, 2024

(51) Int. Cl. G21C 1/07

(52) U.S. Cl. CPC G21C 1/07

(57) ABSTRACT

Advances in creating carbon-free emissions continue with nuclear power. This invention aims to achieve an environment with less radioactive pollution from pebble bed reactors. This invention uses stainless steel, niobium, or ferroniobium which does not form dust like carbon pebbles. The pebble bed reactor coolant will pass over the coated pebbles and not pick up radioactive dust as in old pebble models. This new design is more complicated and costs more than current designs. However, the cleanup of a used pebble bed reactor will be far less, and the health of the workers will be greatly improved through use of this invention. This practical design will enable pebble bed reactors to become approved at a faster rate than old designs.

### CROSS-REFERENCE TO RELATED APPLICATIONS

### Not Applicable.

### STATEMENT REGARDING FEDERALLY SPONSORED RESEARCH OR DEVELOPMENT

There was no federally sponsored research or development which led to the execution of this patent.

### THE NAMES OF THE PARTIES TO A JOINT RESEARCH AGREEMENT

### Not Applicable.

### INCORPORATIONS-BY-REFERENCE OF MATERIAL SUBMITTED ON A READ-ONLY OPTICAL DISC OR AS A TEXT FILE VIA THE OFFICE ELECTRONIC FILING SYSTEM (EFS-WEB)

### Not Applicable.

### STATEMENT REGARDING PRIOR DISCLOSURES BY THE INVENTOR OR A JOINT INVENTOR

There are no prior disclosures by the inventor with respect to this patent.

### BACKGROUND OF THE INVENTION

### (1) Field of the Invention

This invention relates to energy generation. To be more specific, this invention pertains to nuclear fission reactors.

### (2) Description of Related Art Including Information Disclosed Under 37 CFR 1.97 and 1.98

(I) Gunter Lohnert, Ulrich Muller-Frank, Jurgen Heil. U.S. Pat. No. 3,960,656A. 1975.
   Lohnert, Muller-Frank, and Heil invented a pebble bed reactor geometry to maintain constant velocity of all pebbles in the pebble bed reactor.
(II) Helmut Gerwin, Winfried Scherer. U.S. Pat. No. 5,978,434A. 1996.
   Gerwin and Scherer invented a coolant flow geometry which improves coolant flow to the fuel elements.
(III) Unknown. Chinese Patent #CN104756195B. 2012.
   Someone invented a nuclear fuel element which has in the coolant and the fuel inside the spherical solid.

### BRIEF SUMMARY OF THE INVENTION

The invention of this patent pertains to a specially developed coating for pebbles of a pebble bed reactor which minimizes radioactive dust from carbon pebbles. The coating shall consist of stainless steel, pure niobium, or ferroniobium. Stainless steel is much cheaper than pure niobium and ferroniobium but has a lower melting point. A disadvantage with niobium is that at high temperatures it reacts with oxygen in the air. However, this undesired feature can be controlled in an inert gas environment, such as helium. Ferroniobium is simply a mixture of stainless steel and niobium. Current pebble design includes carbon pebbles which over long periods of time the grinding of the pebbles creates a radioactive dust which travels through the coolants and contaminates the reactor vessel and subsequently, the entire nuclear power station.

### BRIEF DESCRIPTION OF THE SEVERAL VIEWS OF THE DRAWING(S)

FIG. 1: New Design of a Pebble of a Pebble Bed Reactor Showing the Flow of the Coolant Passing Around the Pebble

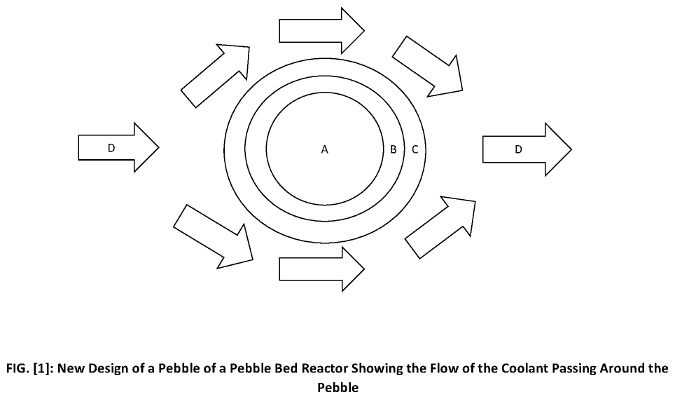

Legend for Drawing in FIG. 1:
A: Region of the pebble bed reactor pebble containing TRISO particles and a carbon matrix
B: Region of the pebble bed reactor pebble containing carbon but no TRISO particles
C: Material which coats the pebble bed reactor pebble developed to minimize radioactive dust from the carbon pebble
D: The flow of the coolant passing outside of the pebble bed reactor pebble

FIG. 2: Old Design of a Pebble of a Pebble Bed Reactor Showing the Flow of the Coolant Passing Around the Pebble

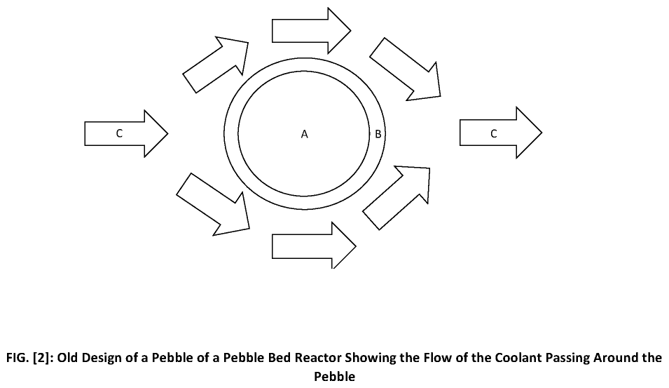

Legend for Drawing in FIG. 2:
A: Region of the pebble bed reactor pebble containing TRISO particles and a carbon matrix
B: Region of the pebble bed reactor pebble containing carbon but no TRISO particles
C: The flow of the coolant passing outside of the pebble bed reactor pebble

### DETAILED DESCRIPTION OF THE INVENTION

The invention of this patent pertains to a specially developed coating for pebbles of a pebble bed reactor which minimizes radioactive dust from carbon pebbles. The coating shall consist of stainless steel, pure niobium, or ferroniobium. The suggested type for stainless steel is either stainless steel 310 or stainless steel 310Cb. Stainless steel is much cheaper than pure niobium and ferroniobium but has a lower melting point. A disadvantage with niobium is that at high temperatures it reacts with oxygen in the air. However, this undesired feature can be controlled in an inert gas environment, such as helium. Ferroniobium is simply a mixture of stainless steel (about 30-40%) and niobium (about 60-70%). Current pebble design includes carbon pebbles which over long periods of time the grinding of the pebbles creates a radioactive dust which travels through the coolants and contaminates the reactor vessel and subsequently, the entire nuclear power station. The suggested thickness of material coating should be 2.5 millimeters. A thickness of 1 millimeter may, over time, become lost due to the grinding of the pebbles in the pebble bed reactor. A coating thickness of 5 millimeters may cause neutronics issues with the pebble bed reactor and decrease its neutron multiplication factor (which is undesirable). If the stainless-steel design is chosen, the pebble bed reactor may have to be lowered to a suitable temperature such that the stainless-steel layer does not go above 1500 Kelvin. This means that the radioactive dust will be greatly reduced and less precautions are to be taken when the pebbles are taken away from the reactor. If the pure niobium coating is chosen, the pebble bed reactor temperature can be worked at a higher temperature and the radioactive dust can be greatly reduced. However, with this design, great precautions will have to be made so that the pebbles can cool in an inert gas environment, so that the pebbles don't react with oxygen in the air.

1: Stainless steel, of a thickness between 1 micrometer and 10 centimeters, which coats a pebble of a pebble bed reactor.

2: Niobium, of a thickness between 1 micrometer and 10 centimeters, which coats a pebble of a pebble bed reactor.

3: Ferroniobium, of a thickness between 1 micrometer and 10 centimeters, which coats a pebble of a pebble bed reactor.
